(19) United States
(12) Patent Application Publication
(10) Pub. No.: US 2013/0145189 A1
(43) Pub. Date: Jun. 6, 2013

(54) SERVER SYSTEM CAPABLE OF DECREASING POWER CONSUMPTION AND METHOD THEREOF

(71) Applicant: YAO-TING CHANG, Tu-Cheng (TW)

(72) Inventor: YAO-TING CHANG, Tu-Cheng (TW)

(73) Assignee: HON HAI PRECISION INDUSTRY CO., LTD., Tu-Cheng (TW)

(21) Appl. No.: 13/337,259

(22) Filed: Dec. 26, 2011

(30) Foreign Application Priority Data
Dec. 5, 2011 (TW) 100144739

(51) Int. Cl. G06F 1/32

(52) U.S. Cl. 713/322

(57) ABSTRACT

A server system and a control method applied therein are illustrated. The server system includes a server cabinet, servers accommodated in the server cabinet, a cooling fan module for cooling the servers, a thermal sensor detecting an ambient temperature in the server cabinet, and a controller. The controller includes a speed control module controlling a rotation speed of the fan module according to the ambient temperature and any overloading of servers, an obtaining module receives power consumed values of the servers, a determining module determining if a ratio of the highest power consumed value to the lowest power consumed value is greater than a predetermined value, and an executing module reducing the clocking speed of the server having the highest power consumed value if the determining module determines that the ratio of the highest power consumed value to the lowest power consumed value is greater than the predetermined value.

### BACKGROUND

1. Technical Field

The present disclosure relates to a server system capable of decreasing the amount of power used and a control method applied in the server system.

2. Description of Related Art

Server systems include a number of servers to satisfy data storing and processing requirements. The sever system may include a fan module for cooling the servers. The rotating speed of the fan module is controlled by a controller according to an ambient temperature in the server system. If only one of the servers is overloaded, the ambient temperature in the server system increases and the fan module is rotated at a faster speed. The higher speed will increase power consumption of the server system.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a server system in accordance with an exemplary embodiment.

FIG. 2 is flowchart of a control method in accordance with an exemplary embodiment.

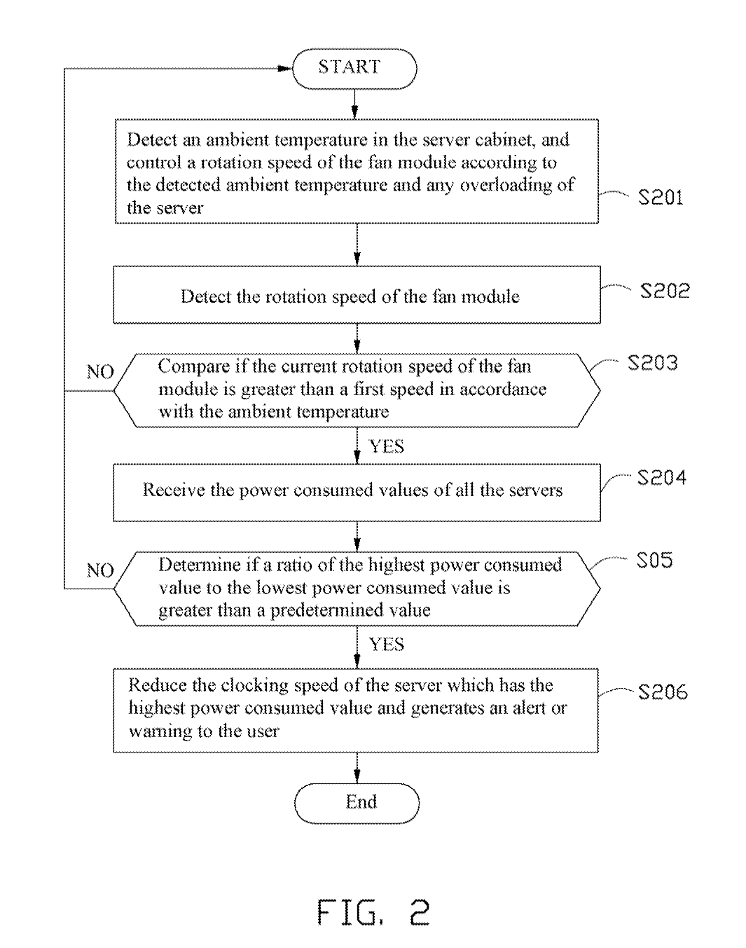

### DETAILED DESCRIPTION

Embodiments of the present disclosure are described with reference to the accompanying drawings.

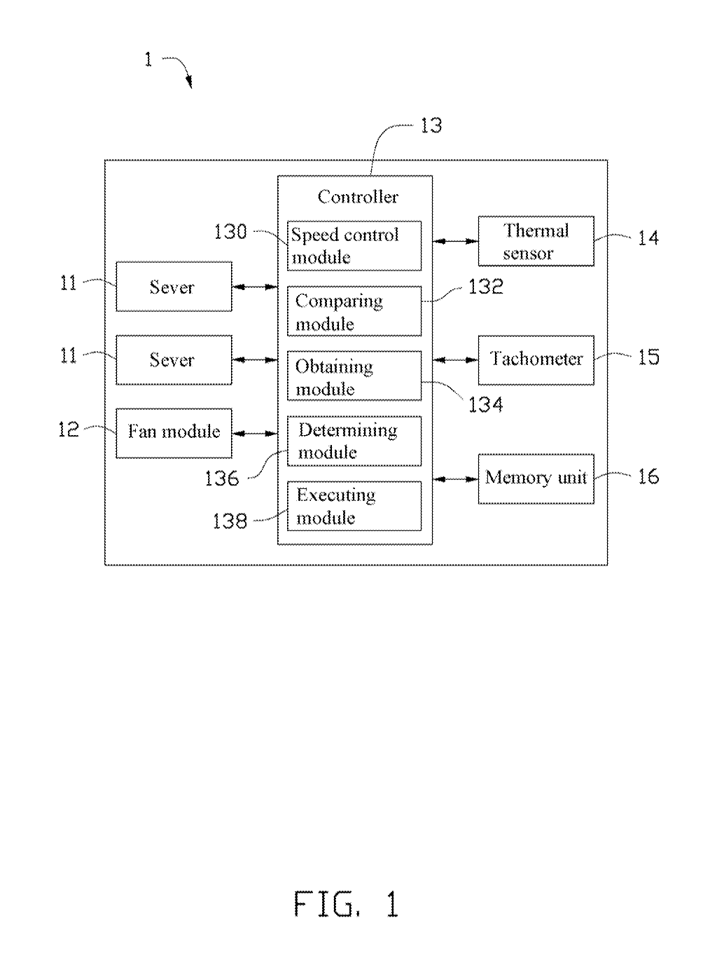

Referring to FIG. 1, a block diagram of a server system 1 according to an exemplary embodiment is illustrated. The server system 1 includes a server cabinet 10, at least two servers 11 accommodated in the server cabinet 10, at least one fan module 12 for cooling the at least two servers 11, a controller 13 for controlling a rotation speed of the fan module 12, a thermal sensor 14, at least one tachometer 15, and a memory unit 16.

The thermal sensor 14 is configured to detect an ambient temperature in the server cabinet 10. The tachometer 15 is configured to detect a rotation speed of the fan module 12. The memory unit 16 stores a table for recording the relationship between ambient temperatures and associated first speeds. An example of the logic control table can be shown as below:

| Server type | Ambient temperature (° C.) | First speed (RPM) |
|---|---|---|
| 20W PCI-E card | 25 | 2000 |
| | 35 | 5000 |
| 205 PCI-E card | 25 | 2500 |
| | 35 | 6000 |

The controller 13 includes a speed control module 130, a comparing module 132, an obtaining module 134, a determining module 136, and an executing module 138. In the embodiment, the controller 13 may be a BIOS (Base Input-Output System) or a BMC (Baseboard Management Controller).

The speed control module 130 controls a rotation speed of the fan module 12 according to the ambient temperature detected by the thermal sensor 14, and according to any overloading of the server 11. If the servers 11 are not overloaded, the speed control module 130 controls the fan module 12 to rotate at the first speed which is associated with the ambient temperature detected by the thermal sensor 14, otherwise the speed control module 130 controls the fan module 12 to rotate at a faster second speed. For example, the server 13 may include a central processing unit (CPU-not shown) and a temperature sensor (not shown) retained in the CPU for detecting a temperature of the CPU. In the embodiment, the temperature of the CPU detected by the temperature sensor is used to determine if the server 11 is overloaded with excessive functions. In detail, if the detected temperature of CPU is greater than 75° C., the controller 13 determines that the server 11 is overloaded with excessive functions and thus controls the fan module 12 to rotate at the second faster speed for cooling a particular server 11.

The comparison module 132 is configured to compare the current rotation speed of the fan module 12 as detected by tachometer with the first speed corresponding to the ambient temperature detected by the thermal sensor 14.

The obtaining module 134 is configured to receive power consumed values of the servers 11.

The determining module 136 determines whether the functions of all the servers 11 are balanced according to the power consumed values provided by the obtaining module 134 if the current rotation speed is greater than the first speed which is associated with the ambient temperature detected by the thermal sensor 14. In the embodiment, if a ratio of the highest power consumed value to the lowest power consumed value is less than a predetermined value, the determining module 136 determines functions of all the servers 11 are balanced, otherwise the determining module 136 determines that functions of all the servers 11 are unbalanced. In the embodiment, the predetermined value is 2.

The executing module 138 is configured to reduce the clocking speed of the server 11 which has the highest power consumed value and generate an alert or warning to the user. Thus the functions of the server 11 which has the greatest power consumed value can be automatically distributed to the other servers 11 to spread the function and decrease the function on a particular server 11. The speed of the fan module 12 is maintained at a first speed in accordance with the ambient temperature until an overload signal is received from a server 11. Thus, the amount of power consumed by the fan module 12 is decreased and kept as low as possible.

A flowchart of a control method applied in the server system 1 in accordance with an exemplary embodiment is illustrated.

In step S201, the thermal sensor 14 detects an ambient temperature in the server cabinet 10, and the speed control module 130 controls a rotation speed of the fan module 12 according to the ambient temperature detected by the thermal sensor 14, and according to any overloading of the server 11.

In step S202, the tachometer 15 detects the rotation speed of the fan module 12.

In step S203, the comparing module 132 compares the current rotation speed of the fan module 12 to a first speed according to the table stored in the memory unit 16, taking into account the current ambient temperature in the server cabinet 10. If the current rotation speed of the fan module 12 is greater than the first speed which is associated with the current ambient temperature in the server cabinet 10, the procedure goes to step S204, otherwise the procedure goes back to step S201.

In step S204, the obtaining module 134 receives the power consumed values of all the servers 11.

In step S205, the determining module 136 determines if a ratio of the highest power consumed value to the lowest power consumed value is greater than a predetermined value. If yes, the procedure goes to step S205, otherwise the procedure goes back to step S201. In the embodiment, the predetermined value is 2.

In step S206, the executing module 138 reduces the clocking speed of the server 11 which has the highest power consumed value and generates an alert or warning to the user.

While various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A server system comprising:
a server cabinet;
at least two servers accommodated in the server cabinet;
at least one fan module for cooling the at least two servers;
a thermal sensor configured to detect an ambient temperature in the server cabinet; and
a controller comprising:
a speed control module configured to control a rotation speed of the at least one fan module according to the ambient temperature detected by the thermal sensor and any overloading of the server;
an obtaining module configured to obtain at least two power consumed values of the at least two servers;
a determining module configured to determines if a ratio of the highest power consumed value to the lowest power consumed value is greater than a predetermined value; and
an executing module configured to reduce the clocking speed of the server which has the highest power consumed value if the determining module determines that the ratio of the highest power consumed value to the lowest power consumed value is greater than the predetermined value.

2. The server system as described in claim 1, further comprising a tachometer configured to configured to detect a current rotation speed of the fan module and a memory unit that stores a table recording the relationship between ambient temperatures and associated first speeds.

3. The server system as described in claim 2, wherein the controller comprises a comparing module configured to compare the current rotation speed of the fan module to a first speed according to the table stored in the memory unit, taking into account the current ambient temperature in the server cabinet 10.

4. The server system as described in claim 1, wherein the predetermined value is 2.

5. The server system as described in claim 1, wherein the executing module further generate an alert or warning to the user if the determining module determines that the ratio of the highest power consumed value to the lowest power consumed value is greater than the predetermined value.

6. The server system as described in claim 1, wherein the controller is a BIOS or a BMC.

7. A method applied in a server system comprising a server cabinet, at least two servers accommodated in the server cabinet, and at least one fan module each for cooling the at least two servers, the method comprising:
detecting an ambient temperature in the server cabinet, and controlling a rotation speed of the fan module according to the ambient temperature detected by the thermal sensor, and according to any overloading of the server;
receives the power consumed values of the at least the servers;
determining if a ratio of the highest power consumed value to the lowest power consumed value is greater than a predetermined value; and
reducing the clocking speed of the server which has the highest power consumed value and generating an alert or warning to the user.

8. The method as described in claim 1, further comprising:
detecting a rotation speed of the at least one fan module; and
comparing the rotation speed of the at least one fan module with a first speed associated with the ambient temperature.

9. The method as described in claim 8, wherein the predetermined value is 2.
